(19) United States
(12) Patent Application Publication
(10) Pub. No.: US 2026/0110980 A1
(43) Pub. Date: Apr. 23, 2026

(54) TONER AND TWO-COMPONENT DEVELOPER

(71) Applicant: Sharp Kabushiki Kaisha, Osaka (JP)

(72) Inventors: OSAMU WADA, Osaka (JP); YORITAKA TSUBAKI, Osaka (JP)

(21) Appl. No.: 19/364,080

(22) Filed: Oct. 21, 2025

(30) Foreign Application Priority Data
Oct. 21, 2024 (JP) 2024-184643

(51) Int. Cl. G03G 9/093; G03G 9/087; G03G 9/09; G03G 9/097; G03G 9/107; G03G 9/113

(52) U.S. Cl. CPC G03G 9/09335; G03G 9/08755; G03G 9/08782; G03G 9/0904; G03G 9/09342; G03G 9/09371; G03G 9/09378; G03G 9/09733; G03G 9/108; G03G 9/1136; G03G 9/1137

(57) ABSTRACT

A toner including toner particles and an external additive adherent to a surface of the toner particles has the following configuration. The toner particles contain an amorphous polyester resin, a crystalline polyester resin, a release agent, and a first fatty acid metal salt. The first fatty acid metal salt includes a trivalent or higher metal ion. The first fatty acid metal salt in the toner particles has an average dispersion size of 50 nm or more and 500 nm or less. The external additive contains a second fatty acid metal salt.

### FIELD OF THE INVENTION

The present disclosure relates to a toner and a two-component developer.

### BACKGROUND ART

A toner which is used in an electrophotographic image forming device such as a copying machine, a multi-function printer, a printer, or a facsimile device (a toner for developing an electrostatic latent image) generally has a constitution in which an external additive is adherent to the surfaces of toner particles (toner cores).

As a toner for developing an electrostatic latent image, for example, a toner having toner particles containing a crystalline polyester resin, an amorphous polyester resin, a higher fatty acid metal salt, and a colorant is known.

### SUMMARY

### Technical Problem

The toner used in an image forming device is required to have a small particle size for the purpose of reducing the consumption amount of the toner and improving the low-temperature fixability of the toner. By enhancing the low-temperature fixability of the toner, power consumption in the image forming device can be reduced.

When an image is formed on a recording sheet with a small toner consumption amount using a small-particle-size toner, a toner layer formed by fixing the toner on the recording sheet becomes a thin layer, and thus it is necessary to increase the colorant density (for example, pigment density) in the toner to secure the image density.

However, when the toner is fixed at a low temperature, as the concentration of the colorant in the toner increases, the image to be formed as the toner layer is more likely to develop cracks originating from the colorant. Thus, there is a problem that the strength (hereinafter, also referred to as “folding strength”) of the image against the folding of the recording sheet decreases. When the folding strength of the formed image is not sufficient, the toner cannot be fixed at a low temperature, and thus, as the colorant concentration in the toner increases, the low-temperature fixability is lowered as a result.

The toner and the two-component developer of the present disclosure have been found in view of such circumstances, and it is a main object of the present disclosure to provide a toner and a two-component developer that are excellent in low-temperature fixability and have sufficient heat-resistant storage stability in that an image having excellent folding strength can be formed while occurrence of low-temperature offset is suppressed in the case of fixing the toner at a low temperature.

### Solution to Problem

A toner of the present disclosure provided to solve the problems described above is a toner including toner particles and an external additive attached to a surface of the toner particles, wherein: the toner particles contain an amorphous polyester resin, a crystalline polyester resin, a release agent, and a first fatty acid metal salt; the first fatty acid metal salt is a trivalent or higher metal salt; the first fatty acid metal salt in the toner particles has an average dispersion size of 50 nm or more and 500 nm or less; and the external additive contains a second fatty acid metal salt.

In the toner, a toner surface exposure ratio of the first fatty acid metal salt calculated as an area proportion of the first fatty acid metal salt to the surface of the toner particles is preferably 1% or more and 5% or less.

In the toner, a content of the first fatty acid metal salt in the toner particles is preferably 0.5 mass % or more and 2.0 mass % or less.

In the toner, a relationship of Formula (1) shown below is preferably satisfied, where a content of the crystalline polyester resin in the toner particles is M_{C} mass %, and a content of the first fatty acid metal salt in the toner particles is M_{TF} mass %.

$$2 \leq {M}_{C} / {M}_{TF} \leq 10 \qquad ( 1 )$$

In the toner, the second fatty acid metal salt preferably has an average particle size of 0.5 μm or more and 1.5 μm or less.

In the toner, a content of the second fatty acid metal salt is preferably 0.1 parts by mass or more and 0.5 parts by mass or less with respect to 100 parts by mass of the toner particles.

In the toner, the second fatty acid metal salt preferably has an adhesion strength of 20% or more with respect to the toner particles.

In the toner, the first fatty acid metal salt preferably includes a hydroxy group.

A two-component developer of the present disclosure provided to solve the problems described above includes the toner and a carrier.

### Advantageous Effects of Invention

The toner and the two-component developer of the present disclosure can exhibit excellent effects such as excellent low-temperature fixability and sufficient heat-resistant storage stability in that an image having excellent folding strength can be formed while occurrence of low-temperature offset is suppressed in the case of fixing the toner at a low temperature.

### BRIEF DESCRIPTION OF THE DRAWINGS

FIG. 1 is a cross-sectional view schematically illustrating a toner according to an embodiment of the present disclosure.

FIG. 2 is a cross-sectional view schematically illustrating a state of an interface between toner particles adjacent to each other at the time of fixing the toner according to an embodiment of the present disclosure.

FIG. 3 is a diagram illustrating an evaluation procedure of folding strength performed at the time of evaluating low-temperature fixability.

FIG. 4 is an enlarged view of the broken line portion in FIG. 3, exemplifying a case where there is no peeling in a toner layer.

FIG. 5 is an enlarged view of the broken line portion in FIG. 3, exemplifying a case where there is peeling in the toner layer.

### DESCRIPTION OF EMBODIMENTS

Hereinafter, a toner and a two-component developer of the present disclosure will be described. In the present disclosure, “internally added” means that an additive is added in such a manner as to be contained inside an additive-receiving material, and “externally added” means that an additive is added in such a manner as to be adherent to an outer surface (surface) of an additive-receiving material.

### 1. Overall Configuration of Toner

The toner according to the present embodiment is a toner including toner particles and an external additive adherent to a surface of the toner particles, the toner satisfying requirements (A) to (D) shown below:
(A) The toner particles contain an amorphous polyester resin, a crystalline polyester resin, a release agent, and a first fatty acid metal salt;
(B) The first fatty acid metal salt is a trivalent or higher metal salt;
(C) The first fatty acid metal salt in the toner particles has an average dispersion size of 50 nm or more and 500 nm or less; and
(D) The external additive contains a second fatty acid metal salt.

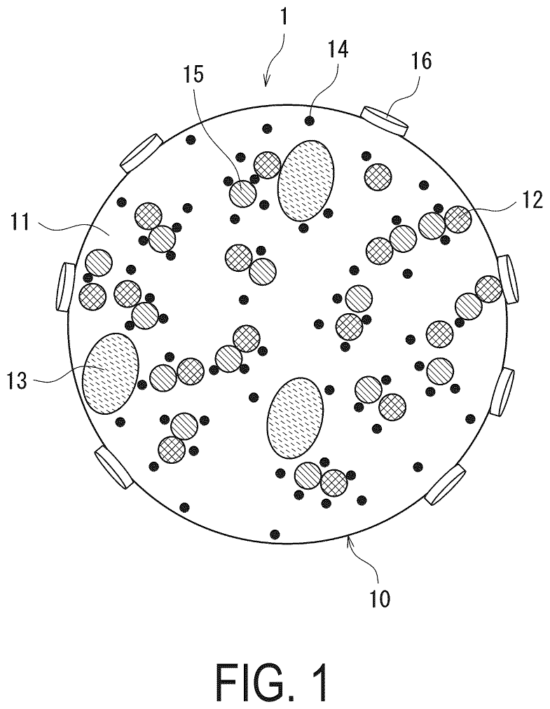

FIG. 1 is a cross-sectional view schematically illustrating a toner 1 according to an embodiment of the present disclosure. In FIG. 1, a toner particle 10 of the toner 1 has a configuration in which a crystalline polyester resin 12, a release agent 13, a colorant 14, and a first fatty acid metal salt 15 are dispersed in an amorphous polyester resin 11 as a binder resin. A second fatty acid metal salt 16 is adherent to the surface of the toner particle 10.

As described above, the first fatty acid metal salt 15 is internally added to the toner particle 10, and the second fatty acid metal salt 16 is externally added to the toner particle 10. The toner 1 may contain other optional components as long as the effects according to the present disclosure are not impaired.

Here, a presumed mechanism in which the toner according to the present embodiment exhibits an effect of “having excellent low-temperature fixability and sufficient heat-resistant storage stability in that an image having excellent folding strength can be formed while occurrence of low-temperature offset is suppressed when fixed at a low temperature” will be described.

In the toner particle 10, a compatible portion where a part of the crystalline polyester resin 12 is compatible with the amorphous polyester resin 11 (for example, a peripheral edge portion of the crystalline polyester resin 12 in FIG. 1) has a large amount of a long-chain fatty acid component. The fatty acid metal salt is composed of a metal ion as the center and a fatty acid component.

The fatty acid component in the first fatty acid metal salt 15 internally added in the toner particle 10 is compatible with a portion where a large amount of the long-chain fatty acid component is present in the crystalline polyester resin 12, that is, with the compatible portion. Thus, the first fatty acid metal salt 15 is well dispersed in the toner particle 10 via the crystalline polyester resin 12, and is uniformly present. This prevents deterioration of the heat-resistant storage stability of the toner due to internal addition of the first fatty acid metal salt 15 to the toner particle 10.

The metal ion in the first fatty acid metal salt 15 interacts with the colorant 14 (pigment as colorant), and the crystalline polyester resin 12 interacts with the amorphous polyester resin 11. Thus, the interaction between the colorant 14 and the amorphous polyester resin 11 is enhanced via the first fatty acid metal salt 15 and the crystalline polyester resin 12 by combining the “interaction between the metal ion in the first fatty acid metal salt 15 and the colorant 14”, the “interaction between the fatty acid component in the first fatty acid metal salt 15 and the long-chain fatty acid component in the crystalline polyester resin 12”, and the “interaction between the crystalline polyester resin 12 and the amorphous polyester resin 11”. As a result, peeling is less likely to occur at the “interface between the colorant 14 and the amorphous polyester resin 11” in the toner particle 10, and the strength of the image to be formed by fixing the toner 1 can be increased. That is, the folding strength of the image can be increased, and a toner having excellent low-temperature fixability can be realized.

Such an effect is obtained by dispersing the first fatty acid metal salt 15 in the toner particle 10 to an appropriate size. When the average dispersion size of the first fatty acid metal salt 15 is larger than 500 nm, the colorant 14 and the amorphous polyester resin 11 do not sufficiently interact with each other in some cases. When the average dispersion size of the first fatty acid metal salt 15 is smaller than 50 nm, the average dispersion size of the crystalline polyester resin 12 also becomes small, and the compatibility between the amorphous polyester resin 11 and the crystalline polyester resin 12 becomes too high. In such a state, the heat-resistant storage stability of the toner deteriorates.

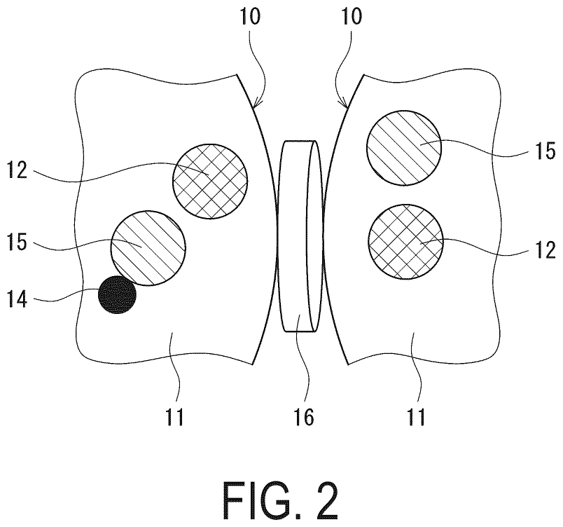

FIG. 2 is a cross-sectional view schematically illustrating a state of an interface between toner particles 10 adjacent to each other at the time of fixing the toner 1 according to an embodiment of the present disclosure. Since the toner 1 contains the second fatty acid metal salt 16 (fatty acid metal salt as an external additive), the second fatty acid metal salt 16 is positioned at the interface between the toner particles 10 adjacent to each other at the time of fixing the toner 1.

When the toner contains a fatty acid metal salt as an external additive, usually, the fatty acid metal salt absorbs heat at the time of fixing the toner because there is an endothermic peak derived from crystallinity of the fatty acid metal salt, and the low-temperature fixability deteriorates.

In contrast, the toner 1 according to the present embodiment contains the first fatty acid metal salt 15, which is a trivalent or higher metal salt, and the crystalline polyester resin 12 as internal additives. Thus, the second fatty acid metal salt 16 present between the toner particles 10 adjacent to each other at the time of toner fixing exhibits the same effect as the effect exhibited by the first fatty acid metal salt 15 in the toner particle 10. This can increase the cohesive force between the toner particles 10.

Specifically, the metal ion in the second fatty acid metal salt 16 interacts with the colorant 14 (pigment as a colorant) in the toner particle 10 and the “metal ion in the first fatty acid metal salt 15”. The fatty acid component in the second fatty acid metal salt 16 is compatible with the “long-chain fatty acid component of the crystalline polyester resin 12” and the “fatty acid component in the first fatty acid metal salt 15” in the toner particle 10. As a result, the second fatty acid metal salt 16 present at the interface between adjacent toner particles 10 exhibits an effect of increasing the cohesive force between the toner particles 10.

According to the above-described presumed mechanism, the cohesive force inside the toner particles 10 and between the toner particles 10 can be increased by employing a toner configuration including both the first fatty acid metal salt 15 (fatty acid metal salt as an internal additive) and the second fatty acid metal salt 16 (fatty acid metal salt as an external additive). In other words, the cohesive force of the entire toner layer formed by fixing the toner 1 can be increased. That is, an image having excellent folding strength can be formed.

Next, the toner particle according to the present embodiment and the constituent components of the toner particle will be described.

### 2. Toner Particle (Toner Core)

The toner particles contain an amorphous polyester resin as a binder resin and an internal additive. The internal additive is dispersed in the binder resin. An external additive is adherent to the surface of the toner particles. The volume-average particle size of the toner particles according to the present embodiment can be appropriately selected according to the purpose, but as described above, the volume-average particle size is preferably 4 μm or more and 10 μm or less, more preferably 5 μm or more and 8 μm or less because the present disclosure solves the problem that occurs when a small-particle-size toner is used.

Hereinafter, each component constituting the toner according to the present embodiment will be described.

### <Polyester Resin>

The toner particles according to the present embodiment contain at least an amorphous polyester resin as a binder resin and a crystalline polyester resin. The crystalline polyester resin can reduce the softening temperature and melt viscosity of the toner. The low-temperature fixability of the toner can be improved by using the crystalline polyester resin in combination with the amorphous polyester resin. When the amorphous polyester resin and the crystalline polyester resin to be used in combination have different raw material origins, specifically, when the main components of the dicarboxylic acid monomer and the polyhydric alcohol are different, the compatibilization of the resins can be more reliably suppressed, and a greater effect of improving the low-temperature fixability can be expected. However, by suppressing the compatibilization of the resins, the crystalline polyester resin is easily isolated from the amorphous polyester resin, and is easily fixed to a developing roller together with the filler component.

In the present disclosure, the amorphous polyester resin and the crystalline polyester resin are distinguished by a crystallinity index. A resin having a crystallinity index of 0.6 or more and 1.5 or less is defined as the crystalline polyester resin, and a resin having a crystallinity index of less than 0.6 or more than 1.5 is defined as the amorphous polyester resin. A resin having a crystallinity index of more than 1.5 is amorphous, and a resin having a crystallinity index of less than 0.6 has low crystallinity and has many amorphous portions.

The crystallinity index is an indicator of the degree of crystallinity of the resin and is defined by the ratio of the softening temperature to the maximum endothermic peak temperature (softening temperature/maximum endothermic peak temperature). Here, the maximum endothermic peak temperature refers to the temperature of the peak on the highest temperature side among the endothermic peaks observed. In the crystalline polyester resin, the maximum peak temperature is used as the melting temperature (melting point, Tmp), and in the amorphous polyester resin, the peak on the highest temperature side is used as the glass transition temperature (Tg).

The degree of crystallinity of the resin can be controlled by adjusting the types and ratios of monomers from which the resin is produced, production conditions (e.g., reaction temperature, reaction time, and cooling rate), and the like.

### —Amorphous Polyester Resin—

The amorphous polyester resin contained in the toner particles according to the present embodiment is obtained by, for example, a polycondensation reaction between a carboxylic acid monomer including terephthalic acid or isophthalic acid as a main component and a polyhydric alcohol including ethylene glycol as a main component.

The reaction conditions are the same as those for the production of a general polyester resin. For example, the amorphous polyester resin is obtained by reacting a dicarboxylic acid monomer and a polyhydric alcohol at 190° C. to 240° C. in a nitrogen gas atmosphere, in the presence of an esterification catalyst as necessary. The reaction ratio between the polyhydric alcohol and the carboxylic acid monomer is preferably 1.3:1 to 1:1.2 in terms of an equivalent ratio between hydroxyl groups and carboxy groups [OH]:[COOH].

The dicarboxylic acid monomer used for synthesis of the amorphous polyester resin includes terephthalic acid or isophthalic acid as a main component. The mole content of terephthalic acid or isophthalic acid in the dicarboxylic acid monomer is preferably 70% or more and 100% or less, more preferably 80% or more and 100% or less.

The dicarboxylic acid monomer may include an aromatic dicarboxylic acid or an aliphatic dicarboxylic acid other than terephthalic acid or isophthalic acid. Examples of the aromatic dicarboxylic acid other than terephthalic acid or isophthalic acid include fumaric acid. Examples of the aliphatic dicarboxylic acid include adipic acid, sebacic acid, and succinic acid. The dicarboxylic acid monomer may include an ester-forming derivative of terephthalic acid or isophthalic acid, an ester-forming derivative of an aromatic dicarboxylic acid other than terephthalic acid or isophthalic acid, an ester-forming derivative of an aliphatic dicarboxylic acid, or the like. In the present disclosure, ester-forming derivatives include carboxylic acid anhydrides, alkyl esters, and the like. One of these dicarboxylic acid monomers may be used individually, or two or more may be used in combination.

In the synthesis of the amorphous polyester resin, a polycarboxylic acid monomer containing three or more carboxyl groups may be used together with the dicarboxylic acid monomer described above. As the polycarboxylic acid monomer containing three or more carboxyl groups, a polycarboxylic acid containing three or more carboxyl groups such as trimellitic acid and pyromellitic acid and an ester-forming derivative thereof can be used. One of these polycarboxylic acid monomers containing three or more carboxyl groups may be used individually, or two or more may be used in combination.

The diol monomer used for synthesis of the amorphous polyester resin includes ethylene glycol as a main component. Here, the mole content of ethylene glycol in the diol monomer is preferably 70% or more and 100% or less, more preferably 80% or more and 100% or less.

The diol monomer may include 1,3-propylene glycol, 1,4-butanediol, and the like. One of these diol monomers may be used individually, or two or more may be used in combination.

The amorphous polyester resin preferably has a glass transition temperature (Tg) of 50° C. or more and 70° C. or less from the viewpoint of the fixability, storage stability, durability, and the like of the toner. When the glass transition temperature is out of this range, the balance among the fixing property, the storage stability, and the durability of the toner may be lost.

The amorphous polyester resin preferably has a softening temperature (Tm) of 100° C. or more and 150° C. or less from the viewpoint of achieving both the low-temperature fixability and the hot offset resistance of the toner. When the softening temperature is out of this range, the balance between the low-temperature fixability and the hot offset resistance of the toner may be lost.

The amorphous polyester resin preferably has a peak-top molecular weight (Mp) of 3000 or more and 10,500 or less from the viewpoint of achieving both the heat-resistant storage stability and the low-temperature fixability of the toner. When the peak-top molecular weight is out of this range, the balance between the heat-resistant storage stability and the low-temperature fixability of the toner may be lost.

Here, the peak-top molecular weight (Mp) means a molecular weight showing the maximum peak height of a THF-soluble component in gel permeation chromatography (GPC) using tetrahydrofuran (THF) as a mobile phase and polystyrene as a standard substance.

The amorphous polyester resins preferably have an acid number of 0 mg KOH/g or more and 60 mg KOH/g or less from the viewpoint of the chargeability of the toner, and a hydroxyl value of 0 mg KOH/g or more and 50 mg KOH/g or less from the viewpoint of the hot offset resistance of the toner. When the acid number is more than 60 mg KOH/g, the chargeability of the toner may deteriorate, and when the hydroxyl value is more than 50 mg KOH/g, the hot offset resistance of the toner may become insufficient.

The amorphous polyester resin preferably has an SP value (solubility parameter) of 10.5 or more and 12.5 or less. When the SP value is less than 10.5, the compatibilization with the crystalline polyester resin proceeds excessively, and the blocking resistance and hot offset resistance of the toner may be impaired. When the SP value is more than 12.5, the compatibility with the crystalline polyester resin is excessively lowered, and the low-temperature fixability may be insufficient.

### —Crystalline Polyester Resin—

In the toner particles according to the present embodiment, the crystalline polyester resin is dispersed in the amorphous polyester resin. The crystalline polyester resin is preferably composed of a linear saturated aliphatic polyester unit obtained through polycondensation between a carboxylic acid monomer including an aliphatic dicarboxylic acid having 9 to 22 carbon atoms as a main component and a polyhydric alcohol including an aliphatic diol having 2 to 10 carbon atoms as a main component.

The reaction conditions are the same as those for the production of a general polyester resin. For example, the crystalline polyester resin is obtained by reacting a carboxylic acid monomer and a polyhydric alcohol at a temperature in a range from 190° C. to 240° C. in a nitrogen gas atmosphere, in the presence of an esterification catalyst as necessary. The reaction ratio between the polyhydric alcohol and the carboxylic acid monomer is preferably from 0.83:1 to 1.3:1 in terms of an equivalent ratio between hydroxyl groups and carboxy groups [OH]:[COOH] from the viewpoint of the preservability of the toner.

The mole content of the dicarboxylic acid in the carboxylic acid monomer is preferably 90% or more and 100% or less. When the mole content of the dicarboxylic acid is low, the crystallization proportion and rate are reduced, and the toner aggregation resistance (difficulty of aggregation of toner) may be insufficient.

Examples of the aliphatic dicarboxylic acid having 9 to 22 carbon atoms include azelaic acid, sebacic acid, 1,10-decanedicarboxylic acid, and 1,18-octadecanedicarboxylic acid. The dicarboxylic acid monomer may include an ester-forming derivative of any of these aliphatic dicarboxylic acids. One of these dicarboxylic acid monomers may be used individually, or two or more may be used in combination.

In the synthesis of the crystalline polyester resin, a polycarboxylic acid monomer containing three or more carboxyl groups may be used together with the dicarboxylic acid monomer described above. As the polycarboxylic acid monomer containing three or more carboxyl groups, a polycarboxylic acid containing three or more carboxyl groups such as trimellitic acid and pyromellitic acid and an ester-forming derivative thereof can be used. One of these polycarboxylic acid monomers containing three or more carboxyl groups may be used individually, or two or more may be used in combination.

Here, the mole content of the aliphatic diol having 2 to 10 carbon atoms in the polyhydric alcohol is preferably 80% or more and 100% or less.

Examples of the aliphatic diol having 2 to 10 carbon atoms include ethylene glycol, 1,4-butanediol, and 1,6-hexanediol. One of these diol monomers may be used individually, or two or more may be used in combination.

In the synthesis of the crystalline polyester resin, a polyol monomer containing three or more hydroxyl groups may be used together with the diol monomer. As the polyol monomer containing three or more hydroxyl groups, glycerol, trimethylolpropane, and the like can be used. One of these polyol monomers containing three or more hydroxyl groups may be used individually, or two or more may be used in combination.

### <First Fatty Acid Metal Salt (Fatty Acid Metal Salt as Internal Additive)>

The toner particles according to the present embodiment contain a first fatty acid metal salt. That is, the first fatty acid metal salt in the present disclosure means a fatty acid metal salt as an internal additive. The fatty acid metal salt is a salt composed of a fatty acid and a metal.

In the present embodiment, a trivalent or higher metal salt is used as the first fatty acid metal salt. By using a trivalent or higher metal salt as the first fatty acid metal salt, a three-dimensional weak cross-linkage can be formed between the crystalline polyester resin and the colorant (pigment as the colorant) in the binder resin, and therefore, the strength of the image to be formed can be enhanced. The first fatty acid metal salt is preferably one in which the metal is aluminum.

The fatty acid in the first fatty acid metal salt may be a saturated fatty acid or an unsaturated fatty acid. Examples of the aliphatic fatty acid include saturated fatty acids such as behenic acid, stearic acid, palmitic acid, myristic acid, and lauric acid; and unsaturated fatty acids such as oleic acid, linoleic acid, and ricinoleic acid. Among these fatty acids, fatty acids having 16 or more carbon atoms are preferable, and stearic acid having 18 carbon atoms is more preferable.

Examples of the fatty acid metal salt in which the metal is aluminum and the fatty acid is stearic acid include aluminum dihydroxystearate and aluminum tristearate.

The first fatty acid metal salt used in the toner particles according to the present embodiment preferably has a hydroxy group (that is, an OH group). When the first fatty acid metal salt has a hydroxy group, the interaction between the first fatty acid metal salt and the colorant is further enhanced, and a toner capable of further exhibiting the effect according to the present disclosure (effect of improving low-temperature fixability to form an image with high folding strength) is obtained. Thus, as the first fatty acid metal salt to be used in the toner particles according to the present embodiment, aluminum dihydroxystearate is particularly suitable.

The average dispersion size of the first fatty acid metal salt in the toner particles according to the present embodiment is 50 nm or more and 500 nm or less, preferably 60 nm or more and 300 nm or less, more preferably 70 nm or more and 150 nm or less. When the average dispersion size of the first fatty acid metal salt exceeds the above upper limit, the interaction between the colorant and the amorphous polyester resin may not sufficiently occur. When the average dispersion size of the first fatty acid metal salt is less than the above lower limit, the average dispersion size of the crystalline polyester resin is also reduced, and the compatibility between the amorphous polyester resin and the crystalline polyester resin becomes too high. Thus, the heat-resistant storage stability as a toner may deteriorate.

The toner surface exposure ratio of the first fatty acid metal salt calculated as the area proportion of the first fatty acid metal salt to the surface of the toner particles according to the present embodiment is preferably 1% or more and 5% or less, more preferably 1.5% or more and 4% or less. When the average dispersion size of the first fatty acid metal salt is within the above range, the cohesive force between the toner particles can be enhanced by the interaction between the first fatty acid metal salt and the second fatty acid metal salt, and an image having excellent folding strength can be formed. That is, a toner having excellent low-temperature fixability can be realized. When the toner surface exposure ratio of the first fatty acid metal salt exceeds the upper limit, the heat-resistant storage stability of the toner may deteriorate. When the toner surface exposure ratio of the first fatty acid metal salt is less than the lower limit, the “interaction between the first fatty acid metal salt and the second fatty acid metal salt” described above does not sufficiently occur, and the effect of improving the low-temperature fixability may not be obtained.

The content of the first fatty acid metal salt in the toner particles according to the present embodiment is preferably 0.5 mass % or more and 2.0 mass % or less, and more preferably 0.7 mass % or more and 1.5 mass % or less. When the content of the first fatty acid metal salt in the toner particles is within the above range, the effect of improving the low-temperature fixability by adding the first fatty acid metal salt to the toner particles can be further exhibited. When the content of the first fatty acid metal salt in the toner particles is less than the lower limit, this effect may not be sufficiently obtained. When the content of the first fatty acid metal salt in the toner particles exceeds the above upper limit, heat-resistant storage stability as a toner may deteriorate.

When the content of the crystalline polyester resin in the toner particles is defined as M_{C} mass %, and the content of the first fatty acid metal salt in the toner particles is defined as M_{TF} mass %, the relationship of Formula (1) shown below is preferably satisfied. The lower limit of M_{C}/M_{TF} in Formula (1) is more preferably 2.5 or more, still more preferably 4 or more. The upper limit of M_{C}/M_{TF} in Formula (1) is more preferably 8 or less, still more preferably 6 or less.

$$2 \leq {M}_{C} / {M}_{TF} \leq 10 \qquad ( 1 )$$

By satisfying the relationship of Formula (1), the first fatty acid metal salt in the toner particles can be controlled to have a more appropriate dispersion size, and the effect of improving the low-temperature fixability by adding the first fatty acid metal salt to the toner particles can be further exhibited. When the M_{C}/M_{TF} is less than the above lower limit, this effect may not be sufficiently obtained. When the M_{C}/M_{TF} exceeds the above upper limit, the amount of the crystalline polyester resin becomes too large, and the heat-resistant storage stability as a toner may deteriorate.

### <Colorant>

The toner particles according to the present embodiment preferably contain a colorant. As the colorant, an organic pigment or an inorganic pigment used in the field of electrophotography can be used, and such a pigment and an organic dye, an inorganic dye, or the like may be used in combination.

Examples of a black colorant include carbon black, copper oxide, manganese dioxide, aniline black, activated carbon, nonmagnetic ferrite, magnetic ferrite, and magnetite.

Examples of a yellow colorant include C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 138, C.I. Pigment Yellow 180, and C.I. Pigment Yellow 185.

Examples of a magenta colorant include C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Examples of a cyan colorant include C.I. Pigment Blue 15, C.I. Pigment Blue 15:2, C.I. Pigment Blue 15:3, C.I. Pigment Blue 16, and C.I. Pigment Blue 60.

The content of the colorant in the toner particles is preferably 3 mass % or more and 15 mass % or less, more preferably 5 mass % or more and 10 mass % or less. The colorant may be used in the form of a masterbatch to uniformly disperse the colorant in the binder resin. When a masterbatch is formed, it is preferable to produce a masterbatch containing a binder resin, a colorant, and the first fatty acid metal salt by adding the first fatty acid metal salt in addition to the binder resin and the colorant. By forming the toner into a masterbatch in this manner, dispersibility of the colorant and the first fatty acid metal salt in the toner particles can be enhanced, and a toner having improved low-temperature fixability and heat-resistant storage stability can be obtained.

### <Release Agent>

The toner particles according to the present embodiment contain a release agent. As the release agent, waxes used in the field of electrophotography can be used, and examples thereof include paraffin wax, microcrystalline wax, Fischer-Tropsch wax, polyethylene wax, polypropylene wax, carnauba wax, and synthetic ester wax. One of these waxes may be used individually, or two or more thereof may be used in combination. The content of the wax in the toner particles may be in a range from 0.5 mass % to 10 mass %, and is preferably 1 mass % or more and 5 mass % or less.

### <Charge Control Agent>

The toner particles according to the present embodiment preferably contain a charge control agent. As the charge control agent, charge control agents for controlling positive charges and for controlling negative charges used in the field of electrophotography can be used.

Examples of the charge control agent for controlling positive charges include nigrosine dyes, basic dyes, quaternary ammonium salts, quaternary phosphonium salts, aminopyrins, pyrimidine compounds, polynuclear polyamino compounds, aminosilanes, nigrosine dyes and derivatives thereof, triphenylmethane derivatives, guanidine salts, and amidine salts.

Examples of the charge control agent for controlling negative charges include oil-soluble dyes such as oil black and spiro black, metal-containing azo compounds, azo complex dyes, naphthenic acid metal salts, metal complexes and metal salts of salicylic acid and derivatives thereof (metals such as chromium, zinc, and zirconium), boron compounds, fatty acid soaps, long-chain alkyl carboxylates, and resin acid soaps.

In the toner according to the present embodiment, one of the above-described charge control agents may be used individually, or two or more thereof may be used in combination.

The content of the charge control agent in the toner particles can be appropriately selected according to the purpose, but is preferably 0.5 mass % or more and 3.0 mass % or less, more preferably 0.7 mass % or more and 2.5 mass % or less. When the content of the charge control agent is within the above range, an image with high image density and high image quality can be formed without impairing various physical properties of the toner.

### 3. External Additive

The toner according to the present embodiment contains at least a second fatty acid metal salt as an external additive. That is, the second fatty acid metal salt in the present disclosure means a fatty acid metal salt as an external additive.

The fatty acid metal salt is a salt composed of a fatty acid and a metal. Examples of the metal in the fatty acid metal salt include aluminum, calcium, potassium, magnesium, barium, lithium, zinc, copper, lead, nickel, strontium, cobalt, and sodium, and in the toner particle according to the present embodiment, it is preferable to use a divalent metal salt as the second fatty acid metal salt. Examples of the divalent metal include magnesium, calcium, barium, and zinc. Among these, zinc is preferable.

The fatty acid in the second fatty acid metal salt may be a saturated fatty acid or an unsaturated fatty acid. Examples of the aliphatic fatty acid include saturated fatty acids such as behenic acid, stearic acid, palmitic acid, myristic acid, and lauric acid; and unsaturated fatty acids such as oleic acid, linoleic acid, and ricinoleic acid. Among these fatty acids, fatty acids having 16 or more carbon atoms are preferable, and stearic acid having 18 carbon atoms is more preferable.

Examples of the fatty acid metal salt include metal salts of stearic acid such as aluminum stearate, calcium stearate, potassium stearate, magnesium stearate, barium stearate, lithium stearate, zinc stearate, copper stearate, lead stearate, nickel stearate, strontium stearate, cobalt stearate, and sodium stearate; metal salts of palmitic acid such as zinc palmitate, cobalt palmitate, copper palmitate, magnesium palmitate, aluminum palmitate, and calcium palmitate; metal salts of lauric acid such as zinc laurate, manganese laurate, calcium laurate, iron laurate, magnesium laurate, and aluminum laurate; metal salts of oleic acid such as zinc oleate, manganese oleate, iron oleate, aluminum oleate, copper oleate, magnesium oleate, and calcium oleate; metal salts of linoleic acid such as zinc linoleate, cobalt linoleate, and calcium linoleate; and metal salts of ricinoleic acid such as zinc ricinoleate and aluminum ricinoleate.

One of these fatty acid metal salts may be used individually, or two or more thereof may be used in combination. Among these, the second fatty acid metal salt according to the present embodiment is preferably a metal salt of stearic acid, more preferably zinc stearate.

The method for producing a fatty acid metal salt is not particularly limited, and examples thereof include a method in which a fatty acid alkali metal salt is cationically substituted and a method in which a fatty acid is directly reacted with a metal hydroxide. When a method for producing zinc stearate as the fatty acid metal salt is taken as an example, examples of the method include a method for substituting sodium stearate with a cation and a method for reacting stearic acid with zinc hydroxide.

The average particle size of the second fatty acid metal salt in the toner according to the present embodiment is preferably 0.5 μm or more and 1.5 μm or less, more preferably 0.5 μm or more and 1.0 μm or less. When the average particle size of the second fatty acid metal salt is within the above range, the effect of increasing the cohesive force between the toner particles at the time of toner fixing is further exhibited, and the strength of the image to be formed can be further increased. When the average particle size of the second fatty acid metal salt is less than the above lower limit, the cohesive force between the toner particles at the time of toner fixing may not be sufficiently obtained. When the average particle size of the second fatty acid metal salt is more than the above upper limit, the influence of the inhibition of fixing by the second fatty acid metal salt may become strong.

The content of the second fatty acid metal salt in the toner according to the present embodiment is preferably 0.1 parts by mass or more and 0.5 parts by mass or less, more preferably 0.2 parts by mass or more and 0.4 parts by mass or less with respect to 100 parts by mass of the toner particles. When the content of the second fatty acid metal salt is within the above range, the effect of increasing the cohesive force between the toner particles at the time of toner fixing is further exhibited, and the strength of the image to be formed can be further increased. When the content of the second fatty acid metal salt is less than the above lower limit, the cohesive force between the toner particles at the time of toner fixing may not be sufficiently obtained. When the content of the second fatty acid metal salt is more than the above upper limit, the influence of the inhibition of fixing by the second fatty acid metal salt may become strong.

In the toner according to the present embodiment, the adhesion strength of the second fatty acid metal salt to toner particles is preferably 20% or more, more preferably 30% or more, still more preferably 35% or more. When the adhesion strength of the second fatty acid metal salt to the toner particles has a value equal to or more than the above lower limit, the second fatty acid metal salt is less likely to be desorbed from the surface of the toner particles while the toner moves from the development tank to the fixing step, and a large amount of the second fatty acid metal salt remains on the surface of the toner particles until the time of toner fixing. Thus, the effect of increasing the cohesive force between the toner particles at the time of toner fixing is further exhibited, and the strength of the image to be formed can be further increased. The adhesion strength can be measured in accordance with “Method for Measuring Adhesion Strength of Second Fatty Acid Metal Salt to Toner Particles” in the Examples described later. The upper limit of the adhesion strength of the second fatty acid metal salt to the toner particles is, for example, 60% or less, preferably 50% or less, more preferably 45% or less.

In the toner according to the present embodiment, an external additive other than the second fatty acid metal salt may be used in combination as long as the effect according to the present disclosure is not impaired, in other words, an external additive other than the second fatty acid metal salt may adhere to the surface of the toner particles. As the external additive other than the second fatty acid metal salt, an external additive used in the field of electrophotography can be used, and for example, inorganic particles such as silica can be used. The average particle size of the inorganic particles is 7 nm or more and 200 nm or less. Particles to which hydrophobicity is imparted by subjecting the surface of the inorganic particles to surface treatment with a hydrophobizing agent such as a silane coupling agent, a titanium coupling agent, or silicone oil are suitable because the decrease in electric resistance and charge amount in a high-humidity environment is small. One of the external additives other than the second fatty acid metal salt may be used individually, or two or more thereof may be used in combination.

The content of the external additive other than the second fatty acid metal salt is preferably 0.5 parts by mass or more and 3 parts by mass or less with respect to 100 parts by mass of the toner particles. For example, when the content of silica particles as an external additive is less than the above lower limit, the effect of improving the fluidity of the toner may be insufficient. When the content of the external additive exceeds the upper limit, the fixability may decrease.

Examples of the silica particles that can be used as the external additive include silica commonly used in the field of electrophotography, for example, fumed silica obtained by burning silicon tetrachloride, dry-process silica such as arc process silica obtained by atomizing silica in a gas phase by high energy such as plasma, precipitated silica synthesized under an alkaline condition using a sodium silicate aqueous solution as a raw material; wet-process silica such as gel process silica synthesized under an acidic condition; colloidal silica obtained by making acidic silicic acid alkaline and polymerizing the acidic silicic acid; and sol-gel process silica obtained by hydrolyzing an organosilane compound. As the silica particles serving as the external additive, commercially available hydrophobized silica particles may be used, or non-hydrophobized silica particles may be subjected to a treatment before use.

Examples of a method for adding the external additive to the toner particles include a method in which the toner particles and the external additive are mixed with an air flow mixer such as a Henschel mixer.

### 4. Two-Component Developer

A two-component developer according to the present embodiment includes the toner according to the present embodiment and a carrier. The two-component developer can be produced by mixing the toner and the carrier using a known mixer. The mass ratio of the toner and the carrier is not particularly limited and is, for example, from 3:97 to 12:88.

The carrier is stirred and mixed with the toner in the development tank and imparts a desired charge to the toner. The carrier functions as an electrode between a development device and the photoreceptor and carries the charged toner to an electrostatic latent image on the photoreceptor to form a toner image. The carrier is held on a developing roller of the development device by magnetic force, used in development, and then returns to the development tank again, where the carrier is stirred and mixed with new toner again. In this manner, the carrier is repeatedly used until the end of its life.

Examples of the carrier include a carrier having a structure including a carrier core material and a resin coating layer coating the carrier core material. The carrier core material is not particularly limited as long as it is used in the electrophotographic field, and may be, for example, a magnetic metal such as iron, copper, nickel, or cobalt; and a magnetic metal oxide such as ferrite or magnetite. The volume-average particle size of the carrier core material is not particularly limited, and is, for example, 30 μm or more and 100 μm or less. The resin coating layer preferably contains a silicone resin or an acrylic resin. The silicone resin can delay the progress of contamination of the resin coating layer, and is suitable for use in a long life.

### EXAMPLES

Hereinafter, the toner and the two-component developer of the present disclosure will be specifically described based on Examples and Comparative Examples.

### 1. Measurement and Calculation Method

### <Method for Calculating SP Value>

The SP value (dissolution parameter) is calculated by the method described in “POLYMER ENGINEERING AND SCIENCE, February 1974, Vol. 14, No. 2, ROBERT F. FEDORS. (pp. 147 to 154)” proposed by Fedors et al.

### <Method for Measuring Volume-Average Particle Size of Toner Particles>

To 50 ml of an electrolytic solution (manufactured by Beckman Coulter, K.K., trade name: ISOTON-II), 20 mg of toner particles and 1 ml of a sodium alkyl ether sulfate are added. The mixture is subjected to dispersion treatment at a frequency of 20 kHz for 3 minutes using an ultrasonic disperser (manufactured by As One Corporation, Desktop Dual Frequency Ultrasonic Cleaner, model: VS-D100) to obtain a measurement sample. The obtained measurement sample is measured using a particle size distribution measuring device (manufactured by Beckman Coulter, K.K., model: Multisizer 3) under conditions of an aperture size of 100 μm and the number of measurement particles of 50000 counts, and the volume-average particle size is determined from the volumetric particle size distribution of the toner particles.

### <Method for Measuring Average Dispersion Size of First Fatty Acid Metal Salt in Toner Particles>

The toner produced in each of Examples and Comparative Examples is embedded in an epoxy resin, and is subjected to surface projection with an ultramicrotome (manufactured by Reichert, trade name: Ultracut N) to produce a sample of a toner particle cross section. The obtained sample is gas-phase stained using a 0.5% aqueous solution of ruthenium tetroxide (VIII), and observed with a scanning transmission electron microscope and an energy dispersive X-ray analyzer (EDX, manufactured by Hitachi High-Technologies Corporation, model: S-4800). While comparing the microscopic image with the EDX image obtained by mapping the Al element or the Zn element, the position and size of the first fatty acid metal salt are specified, and 50 to 100 first fatty acid metal salts are extracted. The circle-equivalent size of the extracted first fatty acid metal salt is determined through image analysis using image analysis software (manufactured by Asahi Kasei Engineering Co., Ltd., trade name: A-Zou Kun), and the average value thereof is calculated as the average dispersion size of the first fatty acid metal salt.

### <Method for Measuring Toner Surface Exposure Ratio of First Fatty Acid Metal Salt>

The toner particles produced in Examples and Comparative Examples (samples before the external addition step in the production procedure described below) are subjected to gas phase staining using a 0.5% aqueous solution of ruthenium tetroxide (VIII), and observed with a scanning transmission electron microscope and an energy dispersive X-ray analyzer (EDX, manufactured by Hitachi High-Technologies Corporation, model: S-4800). The position and size of the first fatty acid metal salt are identified while comparing the microscopic image with the EDX image obtained by mapping the Al element or the Zn element. The position where the first fatty acid metal salt is present is subjected to image analysis with image analysis software (manufactured by Asahi Kasei Engineering Co., Ltd., trade name: A-Zou Kun) to calculate the total area of the first fatty acid metal salt on the surface of the toner particles. The ratio of the total area of the first fatty acid metal salt to the area of the toner particle surface in the microscopic image is calculated as the toner surface exposure ratio.

### <Method for Measuring Adhesion Strength of Second Fatty Acid Metal Salt to Toner Particles>

A toner sample obtained by performing the external additive removal treatment illustrated in the following (1) to (6) is referred to as “Sample 1”, and a toner sample before performing the external additive removal treatment is referred to as “Sample 0”.
(1) To 40 ml of a Triton (polyoxyethylene octylphenyl ether) aqueous solution having a concentration of 0.2 mass %, 2.0 g of the toner is added, and the resulting mixture is stirred for 1 minute.
(2) The aqueous solution is irradiated (power: 40 μA, 4 min) with ultrasonic waves using an ultrasonic homogenizer (manufactured by Nippon Seiki Seisakusho Co., Ltd., model: US-300T).
(3) The aqueous solution after the ultrasonic irradiation is allowed to stand for 3 hours, and the toner and the released external additive are separated.
(4) After removing the supernatant, about 50 ml of pure water is added to the precipitate, and the mixture is stirred for 5 minutes.
(5) The mixture is suction-filtered using a membrane filter with a pore size of 1 μm (manufactured by Advantec Co., Ltd.).
(6) The toner remaining on the filter is vacuum-dried overnight.

Next, the intensity of the specific element in the second fatty acid metal salt in 1 g of each of “Sample 0” and “Sample 1” is analyzed with an X-ray fluorescence spectrometer (manufactured by Rigaku Corporation, model: ZSX Primus II), and the adhesion strength is calculated with Formula (2) shown below. The specific element is “Zn” in fatty acid zinc and “Mg” in fatty acid magnesium.

$$Adhesion strength = ( strength in Sample 1 ) / ( strength in Sample 0 ) \times 100 \qquad ( 2 )$$

### <Method for Measuring Melting Temperature (Melting Point) of Release Agent>

A DSC curve is measured by repeating twice an operation of heating 1 g of a sample from a temperature of 20° C. to 200° C. at a temperature rising rate of 10° C./min and then rapidly cooling the sample from 200° C. to 20° C. using a differential scanning calorimetry (manufactured by Seiko Instruments Inc., model number: DSC220). The temperature of the endothermic peak corresponding to melting in the DSC curve measured in the second operation is defined as the melting temperature.

### <Method for Measuring Glass Transition Temperature (Glass Transition Point) of Polyester Resin>

A DSC curve is measured by heating 1 g of a sample at a temperature rising rate of 10° C./min in accordance with Japanese Industrial Standard (JIS) K7121-1987 using a differential scanning calorimeter (manufactured by Seiko Instruments Inc., model number: DSC220). In the obtained DSC curve, the temperature at the intersection of a straight line obtained by extending the baseline on the high temperature side of the endothermic peak corresponding to glass transition to the low temperature side and a tangent line drawn at a point where the gradient is the maximum with respect to the curve from the rising portion of the peak to the apex is defined as the glass transition temperature (Tg).

### <Method for Measuring Softening Temperature (Softening Point) of Polyester Resin>

Using a flow characteristic evaluation device (manufactured by Shimadzu Corporation, flow tester, model number: CFT-100C), a load of 20 kgf/cm² (9.8×10⁵ Pa) is applied while 1 g of a sample is heated at a temperature rising rate of 6° C./min, and the sample is caused to flow out of a die (nozzle diameter 1 mm, length 1 mm). The temperature at which half of the sample has flowed out is taken as the softening temperature (Tm).

### <Method for Measuring Melting Temperature (Melting Point) of Polyester Resin>

A DSC curve is measured by heating 1 g of a sample to 200° C., cooling the sample to 0° C. at a temperature decrease rate of 10° C./min, and then heating the sample at a temperature increase rate of 10° C./min using a differential scanning calorimetry (manufactured by Seiko Instruments Inc., model number: DSC220). The temperature corresponding to the maximum peak of the endothermic and exothermic heat in the DSC curve is defined as the melting temperature (Tmp).

### <Method for Measuring Acid Value and Hydroxyl Value of Polyester Resin>

The acid value and hydroxyl value of the polyester resin are measured in accordance with Japanese Industrial Standard (JIS) K0070 in 1992 version. When there is a solvent-insoluble component associated with crosslinking in the polyester resin, the polyester resin after being kneaded at 130° C. and 70 rpm for 30 minutes in a kneading device (manufactured by Toyo Seiki Co., Ltd., trade name: Labo Plastomill MODEL 4M150) is used as a sample.

### <Method for Measuring Peak-Top Molecular Weight of Polyester Resin>

The peak-top molecular weight (Mp) of the polyester resin is measured using gel permeation chromatography (GPC) under the following conditions. In the measurement of the molecular weight, a solution obtained by dissolving the polyester resin in tetrahydrofuran (THF) and filtering off insoluble matter with a glass filter is used as a sample. The peak-top molecular weight refers to a molecular weight showing the maximum peak height in a chromatogram obtained by GPC measurement.
Device: manufactured by Tosoh Corporation, HLC-8120
Column: two TSK GEL GMH6 columns manufactured by Tosoh Corporation
Measurement temperature: 40° C.
Sample solution: 0.25 mass % THF solution
Solution injection amount: 100 μL
Detection device: refractive index detector
Reference material: 12 types (molecular weight: 500, 1050, 2800, 5970, 9100, 18,100, 37,900, 96,400, 190,000, 355,000, 1,090,000, 2,890,000) of standard polystyrene (TSK standard POLYSTYRENE) manufactured by Tosoh Corporation

### 2. Production and Preparation of Raw Material

### <Production of Carrier>

A coating resin liquid was prepared by dissolving, in 12 parts by mass of toluene, 0.375 parts by mass of coating resin 1 (silicone-based, manufactured by Shin-Etsu Chemical Co., Ltd., trade name: KR240) and 0.375 parts by mass of coating resin 2 (manufactured by Shin-Etsu Chemical Co., Ltd., trade name: KR251), and then adding and dispersing, in the solution, 0.0375 parts by mass of conductive particles (manufactured by Cabot Corporation, trade name: VULCAN XC-72) and 0.0225 parts by mass of a coupling agent (manufactured by Dow Corning Toray Co., Ltd., trade name: AY43-059). The surface of 100 parts by mass of a ferrite carrier core material having a volume-average particle size of 40 μm was coated with 12.8 parts by mass of the coating resin liquid by an immersion method. Thereafter, the resultant was subjected to a curing process at a curing temperature of 200° C. for a curing time of 1 hour, and sieved with a sieve with an opening of 150 μm to obtain a carrier.

### <Production of Amorphous Polyester Resin A>

In a reaction vessel, 440 g (2.7 mol) of terephthalic acid, 235 g (1.4 mol) of isophthalic acid, 7 g (0.05 mol) of adipic acid, 554 g (8.9 mol) of ethylene glycol, and 0.5 g of tetrabutoxytitanate as a polymerization catalyst were placed. The mixture was reacted at 210° C. under a nitrogen stream for 5 hours while generated water and ethylene glycol were distilled off, and then reacted for 1 hour under a reduced pressure in a range from 5 mmHg to 20 mmHg. Then, 103 g (0.54 mol) of trimellitic anhydride was added, and the mixture was reacted under normal pressure for 1 hour. The mixture was then reacted under reduced pressure in a range from 20 mmHg to 40 mmHg, and a resin was taken out at a predetermined softening point. The recovered ethylene glycol was 219 g (3.5 mol). The obtained resin was cooled to room temperature and then pulverized into particles. This was used as amorphous polyester resin A. The amorphous polyester resin A had a Tg of 56° C., a Tm of 135° C., a peak-top molecular weight Mp of 5000, a SP value of 11.0, an acid value of 37 mg KOH/g, and a hydroxyl value of 50 mg KOH/g.

### <Production of Styrene Acrylic Resin B>

Into a flask substituted with nitrogen, 74 parts by mass of styrene, 26 parts by mass of n-butyl acrylate, and 1.0 parts by mass of methacrylic acid were charged, the internal temperature was raised to 120° C., and then bulk polymerization was performed for 10 hours. Then, 80 parts by mass of xylene was added, and 20 parts by mass of a xylene solution in which 1.5 parts by mass of di-t-butyl peroxide was uniformly dissolved was continuously added over 8 hours while maintaining the temperature at 130° C. The mixture was flushed into a vessel at a temperature of 90° C. and a pressure of 10 mmHg to distill off the solvent and the like, and then coarsely pulverized using a coarse pulverizer to obtain styrene acrylic resin B. The styrene acrylic resin B had a Tm of 140° C. and an SP value of 10.4.

### <Production of Crystalline Polyester Resin C1>

In a reaction vessel, 132 g (1.12 mol) of 1,6-hexanediol, 230 g (1.0 mol) of 1,10-decanedicarboxylic acid, and 3 g of tetrabutoxytitanate as a polymerization catalyst were placed, and the mixture was reacted at 210° C. under normal pressure for 5 hours while generated water was distilled off. Subsequently, the reaction was continued under a reduced pressure in a range from 5 mmHg to 20 mmHg, and a resin was taken out when the acid value became 2 mg KOH/g or less. The obtained resin was cooled to room temperature and then pulverized into particles. This was used as crystalline polyester resin C1. The crystalline polyester resin C1 had a Tmp of 80° C., a Tm of 88° C., a Tm/Tmp of 1.1, a peak-top molecular weight Mp of 30,000, an SP value of 9.5, an acid value of 1 mg KOH/g, and a hydroxyl value of 10 mg KOH/g.

### <Production of Crystalline Polyester Resin C2>

In a reaction vessel, 132 g (1.12 mol) of 1,6-hexanediol, 343 g (1.0 mol) of 1,18-octadecanedicarboxylic acid, and 3 g of tetrabutoxytitanate as a polymerization catalyst were placed, and the mixture was reacted at 210° C. under normal pressure for 5 hours while generated water was distilled off. Thereafter, the reaction was continued under a reduced pressure in a range from 5 mmHg to 20 mmHg, and a resin was taken out when the acid value became 2 mg KOH/g or less. The obtained resin was cooled to room temperature and then pulverized into particles, and the particles were used as crystalline polyester resin C2. The crystalline polyester resin C2 had a Tmp of 75° C., a Tm of 90° C., a Tm/Tmp of 1.2, a peak-top molecular weight Mp of 25,000, an SP value of 9.0, an acid value of 1 mg KOH/g, and a hydroxyl value of 5 mg KOH/g.

### <Production of Crystalline Polyester Resin C3>

In a reaction vessel, 118 g (1.00 mol) of 1,6-hexanediol, 343 g (1.0 mol) of 1,18-octadecanedicarboxylic acid, and 3 g of tetrabutoxytitanate as a polymerization catalyst were placed, and the mixture was reacted at 210° C. under normal pressure for 5 hours while generated water was distilled off. Thereafter, the reaction was continued under a reduced pressure in a range from 5 mmHg to 20 mmHg, and a resin was taken out when the acid value became 2 mg KOH/g or less. The obtained resin was cooled to room temperature and then pulverized into particles, and the particles were used as crystalline polyester resin C3. The crystalline polyester resin C3 had a Tmp of 72° C., a Tm of 90° C., a Tm/Tmp of 1.3, a peak-top molecular weight (Mp) of 25,000, an SP value of 9.9, an acid value of 0 mg KOH/g, and a hydroxyl value of 3 mg KOH/g.

### <Preparation of First Fatty Acid Metal Salt (Fatty Acid Metal Salt as Internal Additive)>

As the first fatty acid metal salt, the following fatty acid metal salts as trivalent metal salts were used.
Fatty acid metal salt “TGM1”: aluminum dihydroxystearate (fatty acid metal salt having an OH group, manufactured by NOF CORPORATION, trade name: aluminum stearate 300)
Fatty acid metal salt “TGM2”: aluminum tristearate (fatty acid metal salt having no OH groups, manufactured by NOF CORPORATION, trade name: aluminum stearate 900)

### <Production of Second Fatty Acid Metal Salt (Fatty Acid Metal Salt as External Additive)>

### —Production of Fatty Acid Metal Salt “DFM1”—

To 10,000 parts by mass of ethanol, 1422 parts by mass of stearic acid was added, they were mixed at a liquid temperature of 75° C., then 507 parts by mass of zinc hydroxide was added little by little, and the resulting material was stirred and mixed for 1 hour after the completion of the addition. Thereafter, the mixture was cooled to a liquid temperature of 20° C., the product was separated through filtration to remove ethanol and the reaction residue, and a solid was taken out. The solid taken out was dried at 150° C. for 3 hours using a heating-type vacuum dryer. The solid was taken out from the drier and allowed to cool, and then the obtained solid of zinc stearate was coarsely pulverized using a power mill (manufactured by Dalton Corporation, model: P-3) having a screen of φ2 mm to obtain a coarsely pulverized product.

The obtained coarsely pulverized product was finely pulverized using a jet pulverizer (manufactured by Nippon Pneumatic Mfg. Co., Ltd., model: IDS-2) to obtain a finely pulverized product, and then classified using an elbow-jet classifier (manufactured by Nittetsu Mining Co., Ltd., model: EJ-LABO) to obtain a second fatty acid metal salt DFM1 that is zinc stearate. The average particle size of the second fatty acid metal salt DFM1 was 0.7 μm.

### —Production of Fatty Acid Metal Salts “DFM2” to “DFM5”—

Fatty acid metal salts “DFM2” to “DFM5” having different average particle sizes were produced in the same manner as in the above “Production of Fatty Acid Metal Salt DFM1” except that the finely pulverizing conditions and the classification conditions were changed. The average particle size is as shown in Table 1 below.

### —Production of Fatty Acid Metal Salt “DFM6”—

A fatty acid metal salt “DFM6” of magnesium stearate was produced in the same manner as in the “Production of Fatty Acid Metal Salt “DFM1”” except that 507 parts by mass of zinc hydroxide was changed to 293 parts by mass of magnesium hydroxide and the fine pulverization conditions and the classification conditions were changed. The average particle size of the second fatty acid metal salt DFM6 was 1.0 μm. The compound names and average particle sizes of the fatty acid metal salts DFM1 to DFM6 are collectively shown in Table 1 below.

TABLE 1

| Sample | Average | |
|---|---|---|
| name | particle size | Compound name |
| DFM1 | 0.7 μm | Zinc stearate |
| DFM2 | 1.5 μm | Zinc stearate |
| DFM3 | 0.5 μm | Zinc stearate |
| DFM4 | 0.3 μm | Zinc stearate |
| DFM5 | 2.0 μm | Zinc stearate |
| DFM6 | 1.0 μm | Magnesium stearate |

### 3. Production of Toner and Two-Component Developer

### <Toner Production Step>

### Example 1

### —First Melt-Kneading Step—

In the first melt-kneading step, the following raw materials were used.
Binder resin

“Amorphous polyester resin A” described above: 65.0 mass %
Colorant

Carbon black (manufactured by Cabot Corporation, trade name: Regal330): 30.0 mass %
First fatty acid metal salt

Fatty acid metal salt “TFM1” described above: 5.0 mass %

The above-described raw materials were premixed for 5 minutes using a Henschel mixer (manufactured by Nippon Coke & Engineering Co., Ltd., model: FM20C) and then melt-kneaded under the following conditions using an open roll-type continuous kneader (manufactured by Nippon Coke & Engineering Co., Ltd., model: MOS320-1800), to obtain a first melt-kneaded product.
Temperature on feed side/emit side of heating roll: 130° C./100° C.
Temperature on feed side/emit side of cooling roll: 40° C./25° C.
Heating roll and cooling roll: diameter 320 mm, effective length 1550 mm
Gap between rolls on feed side and emit side: 0.3 mm
Heating roll rotation speed/cooling roll rotation speed: 75 rpm/65 rpm
Raw material feeding rate: 5.0 kg/hour

### —Second Melt-Kneading Step—

In the second melt-kneading step, the following raw materials were used.
Binder resin

“Amorphous polyester resin A” described above: 71.0 mass %
“First melt-kneaded product” obtained in the first melt-kneading step: 20.0 mass %
Crystalline polyester resin

“Crystalline polyester resin C1” described above: 5.0 mass %
Charge control agent

Salicylic acid compound (manufactured by Orient Chemical Industries Co., Ltd., trade name: Bontron E-84): 1.0 mass %
Release agent

Ester wax (manufactured by NOF Corporation, trade name: WE-15): 3.0 mass %

The raw materials described above were pre-mixed for 5 minutes using a Henschel mixer (manufactured by NIPPON COKE & ENGINEERING CO., LTD., model: FM20C), and then melt-kneaded using a twin-screw extruder at a cylinder setting temperature of 110° C., a barrel rotation speed of 200 rpm, and a raw material feeding rate of 15 kg/hour to obtain a melt-kneaded product.

### —Coarse Pulverization/Fine Pulverization Step—

The obtained melt-kneaded product was cooled with a cooling belt, and then coarsely pulverized using a power mill (manufactured by Dalton Corporation, model: P-3) having a φ 2 mm screen to obtain a coarsely pulverized product.

The obtained coarsely pulverized product was finely pulverized using a jet-type pulverizer (manufactured by Nippon Pneumatic Mfg. Co., Ltd., model: IDS-2) to obtain a finely pulverized product.

### —Classification Step—

Subsequently, the obtained finely pulverized product was classified using an elbow jet classifier (manufactured by Nittetsu Mining Co., Ltd., model: EJ-LABO), and toner particles having a volume-average particle size of 6.7 μm were obtained.

### —External Addition Step—

To 100 parts by mass of the obtained toner particles, 1.0 parts by mass of silica particles (average particle size: 7 nm, manufactured by Nippon Aerosil Co., Ltd., trade name: R976S) was added, and the mixture was stirred for 1 minute in a Henschel mixer (manufactured by NIPPON COKE & ENGINEERING CO., LTD., model: FM20C) in which the tip speed of a stirring blade was set to 40 m/sec. Then, 0.3 parts by mass of the fatty acid metal salt “DFM1” as the second fatty acid metal salt was added, and the mixture was stirred for 5 minutes, in which the tip speed of the Henschel mixer was set to 40 m/sec, whereby a toner was obtained. The adhesion strength of the second fatty acid metal salt to the toner particles in the obtained toner was 40%.

### <Two-Component Developer Production Step>

The obtained toner and the carrier produced in the above “Production of Carrier” were adjusted such that the toner concentration with respect to the total amount of the two-component developer was 7%, and they were mixed for 20 minutes with a V-type mixer (manufactured by TOKUJU CORPORATION, model: V-5) to obtain a two-component developer having a toner concentration of 7%.

### Examples 2 to 22 and Comparative Examples 1 to 7

Toners and two-component developers of Examples 2 to 22 and Comparative Examples 1 to 7 were obtained in the same manner as in Example 1 except that the types and addition amounts of the constituent components of the raw materials were changed as shown in Tables 2 and 3 below, and the conditions in the external addition step (the external addition conditions of the second fatty acid metal salt) were controlled to change the adhesion strength of the second fatty acid metal salt to the toner particles. In Tables 2 and 3, “Crystalline Pes” means a crystalline polyester resin, “Amorphous PesA” means the amorphous polyester resin A, and “St-AcB” means the styrene acrylic resin B.

In Examples 2 to 10 and Comparative Examples 1 and 2, the average dispersion size of the first fatty acid metal salt in the toner particles is controlled by adjusting the type of the crystalline polyester resin and the ratio of the addition amounts of the crystalline polyester resin and the first fatty acid metal salt. More specifically, when the “crystalline polyester resin C2” is used as the crystalline polyester resin, the average dispersion size of the first fatty acid metal salt tends to increase, and when the “crystalline polyester resin C3” is used as the crystalline polyester resin, the average dispersion size of the first fatty acid metal salt tends to decrease. This is considered to be because the degree of compatibility between the crystalline polyester resin and the amorphous polyester resin affects the dispersion state of the crystalline polyester resin.

In Examples 19 and 20, by changing the stirring time with the Henschel mixer after the second fatty acid metal salt was charged in the external addition step from that in Example 1, toners and two-component developers having different adhesion strength of the second fatty acid metal salt were obtained. Specifically, in Example 19, the stirring time was changed to 2 minutes, and in Example 20, the stirring time was changed to 1 minute.

TABLE 2

| | | | | First fatty acid metal salt (internally added) | | | | | |
|---|---|---|---|---|---|---|---|---|---|
| | Crystalline Pes | | | | | Average | | Surface | Presence or |
| | | Addition | Binder resin | | | dispersion | Addition | exposure | absence of |
| | Types | amount | Types | Types | Valence | size | amount | ratio | OH group |
| Example 1 | C1 | 5.0 parts | Amorphous PesA | TFM1 | 3 | 100 nm | 1.0 parts | 2.00% | Present |
| Example 2 | C3 | 3.0 parts | Amorphous PesA | TFM1 | 3 | 50 nm | 0.7 parts | 0.70% | Present |
| Example 3 | C2 | 5.0 parts | Amorphous PesA | TFM1 | 3 | 500 nm | 1.5 parts | 6.00% | Present |
| Example 4 | C2 | 5.0 parts | Amorphous PesA | TFM1 | 3 | 60 nm | 0.5 parts | 1.00% | Present |
| Example 5 | C1 | 5.0 parts | Amorphous PesA | TFM1 | 3 | 300 nm | 2.0 parts | 5.00% | Present |
| Example 6 | C1 | 4.0 parts | Amorphous PesA | TFM1 | 3 | 80 nm | 0.5 parts | 1.20% | Present |
| Example 7 | C2 | 2.0 parts | Amorphous PasA | TFM1 | 3 | 200 nm | 0.3 parts | 1.50% | Present |
| Example 8 | C3 | 5.0 parts | Amorphous PesA | TFM1 | 3 | 350 nm | 2.5 parts | 4.50% | Present |
| Example 9 | C1 | 1.0 parts | Amorphous PesA | TFM1 | 3 | 400 nm | 1.0 parts | 3.50% | Present |
| Example 10 | C1 | 6.0 parts | Amorphous PesA | TFM1 | 3 | 50 nm | 0.5 parts | 0.80% | Present |
| Example 11 | C1 | 5.0 parts | Amorphous PesA | TFM1 | 3 | 100 nm | 1.0 parts | 2.00% | Present |
| Example 12 | C1 | 5.0 parts | Amorphous PesA | TFM1 | 3 | 100 nm | 1.0 parts | 2.00% | Present |
| Example 13 | C1 | 5.0 parts | Amorphous PesA | TFM1 | 3 | 100 nm | 1.0 parts | 2.00% | Present |
| Example 14 | C1 | 5.0 parts | Amorphous PesA | TFM1 | 3 | 100 nm | 1.0 parts | 2.00% | Present |
| Example 15 | C1 | 5.0 parts | Amorphous PosA | TFM1 | 3 | 100 nm | 1.0 parts | 2.00% | Present |
| Example 16 | C1 | 5.0 parts | Amorphous PesA | TFM1 | 3 | 100 nm | 1.0 parts | 2.00% | Present |
| Example 17 | C1 | 5.0 parts | Amorphous PesA | TFM1 | 3 | 100 nm | 1.0 parts | 2.00% | Present |
| Example 18 | C1 | 5.0 parts | Amorphous PesA | TFM1 | 3 | 100 nm | 1.0 parts | 2.00% | Present |
| Example 19 | C1 | 5.0 parts | Amorphous PosA | TFM1 | 3 | 100 nm | 1.0 parts | 2.00% | Present |
| Example 20 | C1 | 5.0 parts | Amorphous PesA | TFM1 | 3 | 100 nm | 1.0 pans | 2.00% | Present |
| Example 21 | C1 | 5.0 parts | Amorphous PesA | TFM2 | 3 | 150 nm | 1.0 parts | 2.00% | Absent |
| Example 22 | C1 | 5.0 parts | Amorphous PesA | TFM1 | 3 | 100 nm | 1.0 parts | 2.00% | Present |

| | Second fatty acid metal salt (externally | | | | |
|---|---|---|---|---|---|
| | added) | | | | Relationship |
| | | Average | | | of addition |
| | | particle | Addition | Adhesion | amount |
| | Types | size | amount | strength | [M_{C}]/[M_{TF}] |
| Example 1 | DFM1 | 0.7 μm | 0.3 parts | 40% | 5 |
| Example 2 | DFM1 | 0.7 μm | 0.3 parts | 40% | 4.3 |
| Example 3 | DFM1 | 0.7 μm | 0.3 parts | 40% | 3.3 |
| Example 4 | DFM1 | 0.7 μm | 0.3 parts | 40% | 10 |
| Example 5 | DFM1 | 0.7 μm | 0.3 parts | 40% | 2.5 |
| Example 6 | DFM1 | 0.7 μm | 0.3 parts | 40% | 8 |
| Example 7 | DFM1 | 0.7 μm | 0.3 parts | 40% | 6.7 |
| Example 8 | DFM1 | 0.7 μm | 0.3 party | 40% | 2 |
| Example 9 | DFM1 | 0.7 μm | 0.3 parts | 40% | 3 |
| Example 10 | DFM1 | 0.7 μm | 0.3 pants | 40% | 12 |
| Example 11 | DFM2 | 1.5 μm | 0.3 parts | 30% | 5 |
| Example 12 | DFM3 | 0.5 μm | 0.3 parts | 50% | 5 |
| Example 13 | DFM4 | 0.3 μm | 0.3 parts | 60% | 5 |
| Example 14 | DFM5 | 2.0 μm | 0.3 parts | 20% | 5 |
| Example 15 | DFM1 | 0.7 μm | 0.1 parts | 50% | 5 |
| Example 16 | DFM1 | 0.7 μm | 0.5 parts | 35% | 5 |
| Example 17 | DFM1 | 0.7 μm | 0.05 parts | 55% | 5 |
| Example 18 | DFM1 | 0.7 μm | 0.8 parts | 25% | 5 |
| Example 19 | DFM1 | 0.7 μm | 0.3 parts | 20% | 5 |
| Example 20 | DFM1 | 0.7 μm | 0.3 parts | 10% | 5 |
| Example 21 | DFM1 | 0.7 μm | 0.3 parts | 40% | 5 |
| Example 22 | DFM6 | 1.0 μm | 0.3 parts | 35% | 5 |

TABLE 3

| | | | | First fatty acid metal salt (internally added) | | | | | |
|---|---|---|---|---|---|---|---|---|---|
| | Crystalline Pes | | | | | Average | | Surface | Presence or |
| | | Addition | Binder resin | | | dispersion | Addition | exposure | absence of |
| | Types | amount | Types | Types | Valence | size | amount | ratio | OH group |
| Comparative | C3 | 3.0 parts | Amorphous | TFM1 | 3 | 30 nm | 0.5 parts | 0.50% | Present |
| Example 1 | | | PesA | | | | | | |
| Comparative | C2 | 4.0 parts | Amorphous | TFM1 | 3 | 800 nm | 2.0 parts | 8.00% | Present |
| Example 2 | | | PasA | | | | | | |
| Comparative | C1 | 5.0 parts | Amorphous | Absent | — | — | — | — | — |
| Example 3 | | | PasA | | | | | | |
| Comparative | C1 | 5.0 parts | Amorphous | DFM1 | 2 | 350 nm | 1.0 parts | 3.50% | Absent |
| Example 4 | | | PesA | | | | | | |
| Comparative | C1 | 5.0 parts | Amorphous | TFM1 | 3 | 100 nm | 1.0 parts | 2.00% | Present |
| Example 5 | | | PasA | | | | | | |
| Comparative | Absent | — | Amorphous | TFM1 | 3 | 100 nm | 1.0 parts | 2.00% | Present |
| Example 6 | | | PesA | | | | | | |
| Comparative | C1 | 5.0 parts | St-AcB | TFM1 | 3 | 100 nm | 1.0 parts | 2.00% | Present |
| Example 7 | | | | | | | | | |

| | Second fany acid metal salt (externally | | | | |
|---|---|---|---|---|---|
| | added) | | | | Relationship |
| | | Average | | Adhesion | of addition |
| | Types | particle | Addition | strength | [M_{C}]/[M_{TF}] |
| Comparative | DFM1 | 0.7 μm | 0.3 parts | 40% | 6 |
| Example 1 | | | | | |
| Comparative | DFM1 | 0.7 μm | 0.3 parts | 40% | 2 |
| Example 2 | | | | | |
| Comparative | DFM1 | 0.7 μm | 0.3 parts | 40% | — |
| Example 3 | | | | | |
| Comparative | DFM1 | 0.7 μm | 0.3 parts | 40% | 5 |
| Example 4 | | | | | |
| Comparative | Absent | — | — | — | 5 |
| Example 5 | | | | | |
| Comparative | DFM1 | 0.7 μm | 0.3 parts | 40% | — |
| Example 6 | | | | | |
| Comparative | DFM1 | 0.7 μm | 0.3 parts | 40% | 5 |
| Example 7 | | | | | |

### 4. Evaluation

### <Evaluation Item 1: Heat-Resistant Storage Stability>

Heat-resistant storage stability was evaluated based on the presence or absence of aggregates after high-temperature storage.

In a wide-mouth cylindrical polycontainer having a capacity of 250 ml, 20 g of the toner was put and sealed, and the container was left to stand in an environment at a temperature of 50° C. for 72 hours, and then the toner was taken out and sieved with a 230-mesh sieve. The mass of the toner remaining on the sieve was measured, and the residual proportion, which is the proportion of the mass to the total mass of the toner (20 g), was calculated. Based on the residual proportion, the “heat-resistant storage stability” of the toner was evaluated according to the following criteria.
⊚ (Excellent): No aggregation. The residual proportion is less than 0.5%.
◯ (Good): Slight amount of aggregation. The residual proportion is 0.5% or more and less than 7%.
Δ (Acceptable): Large amount of aggregation. The residual proportion is 7% or more and less than 12%.
x (Not acceptable): Large amount of aggregation. The residual proportion is 12% or more.

### <Evaluation Item 2: Low-Temperature Fixability>

A fixed image was produced with the two-component developer using a commercially available copying machine (manufactured by Sharp Corporation, model: MX-5100FN) modified for evaluation.

First, a sample image including a solid image (a rectangle with a length of 20 mm and a width of 50 mm) was formed as an unfixed image on a recording sheet (PPC sheet manufactured by Sharp Corporation, product number: SF-4AM3). At this time, the adhesion amount of the toner to the recording sheet in the solid image was adjusted to 0.5 mg/cm².

Next, a fixed image was formed using a belt fixing device. The fixing process speed was set to 140 mm/sec, and the temperature of the fixing belt was raised from 95° C. in increments of 5° C. to determine the temperature range in which “low-temperature offset” did not occur and there was no problem in “evaluation of folding strength”.

Here, the “low-temperature offset” means that the toner is not fixed to the recording sheet at the time of fixing, and is adherent to the recording sheet after the fixing belt makes one revolution while the toner is adherent to the fixing belt.

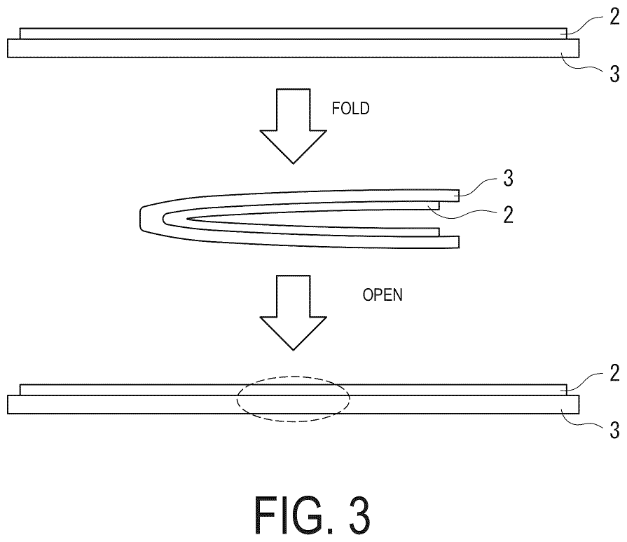

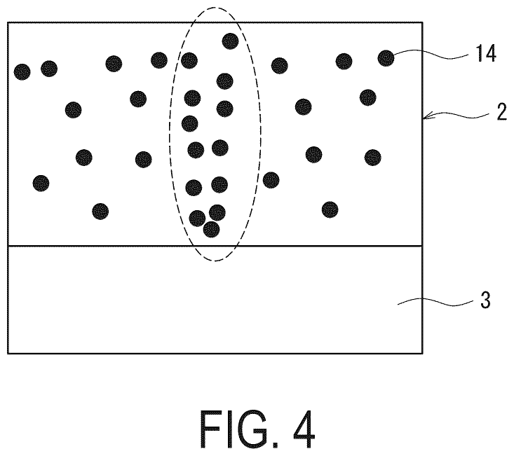

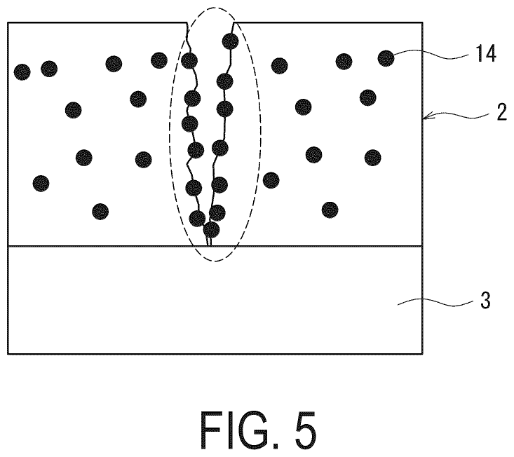

The “evaluation of folding strength” was performed according to the procedure shown in FIG. 3. Specifically, a recording sheet (recording sheet 3 in FIG. 3) on which the solid image (toner layer 2 in FIG. 3) was formed was folded, and a weight of 1 kg was placed on the folded portion and rubbed once to form a crease. Next, the folded recording sheet was opened, another PPC sheet (manufactured by Sharp Corporation, product number: PP106A4C) was superimposed on the portion where the fold line of the solid image was formed, a weight of 1 kg was placed thereon and rubbed, and it was visually confirmed whether there was a portion where the image was missing to white on the fold line of the solid image (that is, whether there was a peeled portion where the toner layer 2 was peeled in the broken line portion in FIG. 3). Here, FIGS. 4 and 5 are enlarged views of the broken line portion in FIG. 3. FIG. 4 is a diagram illustrating a case where there is no peeling in the toner layer 2, and FIG. 5 is a diagram illustrating a case where there is peeling in the toner layer 2. When there is peeling in the toner layer 2 as illustrated in FIG. 5, a portion where the image is missing to white is generated.

Based on the results of the visual confirmation, the test piece was ranked in five grades according to the following criteria, and when the test piece was ranked 3 or more, it was determined that there was no problem in the “evaluation of folding strength”.
Rank 5: There is little peeling on the fold.
Rank 4: Fine peeling is observed on a part of the fold.
Rank 3: There is intermittent fine linear peeling on the fold.
Rank 2: There is continuous peeling in the form of a thick line on the fold.
Rank 1: There is large peeling on the fold.

When “low-temperature offset” did not occur and there was no problem in “evaluation of folding strength”, the low-temperature fixability at that temperature was determined to be passed. The determination was performed for each temperature in this manner, and the “low-temperature fixability” was evaluated based on the lowest temperature at which the toner was determined to be passed (that is, the low-temperature fixable temperature) according to the following criteria.
⊚ (Excellent): The lowest temperature is less than 105° C.
◯ (Good): The lowest temperature is 105° C. or more and less than 120° C.
Δ (Acceptable): The lowest temperature is 120° C. or more and less than 130° C.
x (Not acceptable): The lowest temperature is 130° C. or more.

TABLE 4

| | | | Low-temperature fixability | |
|---|---|---|---|---|
| | | | Minimum | |
| | | | temperature | |
| | Heat-resistant storage | | (Low- | |
| | stability | | temperature | |
| | Residual | | side fixable | |
| | proportion | Evaluation | temperature) | Evaluation |
| Example 1 | 2.0% | ◯ | 95° C. | ⊚ |
| Example 2 | 11.5% | Δ | 115° C. | Δ |
| Example 3 | 11.2% | Δ | 115° C. | Δ |
| Example 4 | 0.4% | ⊚ | 105° C. | ◯ |
| Example 5 | 6.0% | ◯ | 95° C. | ⊚ |
| Example 6 | 0.3% | ⊚ | 110° C. | ◯ |
| Example 7 | 6.0% | ◯ | 120° C. | Δ |
| Example 8 | 11.5% | Δ | 100° C. | ◯ |
| Example 9 | 3.0% | ◯ | 120° C. | Δ |
| Example 10 | 10.0% | Δ | 100° C. | ◯ |
| Example 11 | 3.0% | ◯ | 100° C. | ◯ |
| Example 12 | 1.7% | ◯ | 100° C. | ◯ |
| Example 13 | 1.5% | ◯ | 115° C. | Δ |
| Example 14 | 4.5% | ◯ | 115° C. | Δ |
| Example 15 | 1.8% | ◯ | 105° C. | ◯ |
| Example 16 | 3.5% | ◯ | 105° C. | ◯ |
| Example 17 | 1.6% | ◯ | 120° C. | Δ |
| Example 18 | 4.5% | ◯ | 115° C. | Δ |
| Example 19 | 1.8% | ◯ | 105° C. | ◯ |
| Example 20 | 1.6% | ◯ | 115° C. | Δ |
| Example 21 | 7.5% | Δ | 100° C. | ◯ |
| Example 22 | 3.0% | ◯ | 95° C. | ⊚ |
| Comparative | 15.5% | X | 120° C. | Δ |
| Example 1 | | | | |
| Comparative | 14.5% | X | 120° C. | Δ |
| Example 2 | | | | |
| Comparative | 1.0% | ◯ | 130° C. | X |
| Example 3 | | | | |
| Comparative | 12.0% | X | 110° C. | ◯ |
| Example 4 | | | | |
| Comparative | 1.5% | ◯ | 125° C. | X |
| Example 5 | | | | |
| Comparative | 0.5% | ⊚ | 150° C. | X |
| Example 6 | | | | |
| Comparative | 31.0% | X | 140° C. | X |
| Example 7 | | | | |

Table 4 shows the evaluation results of the low-temperature fixability (performance of forming an image having excellent folding strength while suppressing the occurrence of low-temperature offset) and the heat-resistant storage stability in each of Examples and Comparative Examples. According to Table 4, the toners of Examples 1 to 22, which were toners having an external additive adherent to the surface of the toner particles and satisfied the following requirements (A) to (D), had excellent low-temperature fixability and sufficient heat-resistant storage stability.
(A) The toner particles contain an amorphous polyester resin, a crystalline polyester resin, a release agent, and a first fatty acid metal salt;
(B) The first fatty acid metal salt is a trivalent or higher metal salt;
(C) The first fatty acid metal salt in the toner particles has an average dispersion size of 50 nm or more and 500 nm or less; and
(D) The external additive contains a second fatty acid metal salt.

On the other hand, in Comparative Examples 1 to 7, which did not satisfy these requirements, at least one of the evaluations of the low-temperature fixability and the heat-resistant storage stability was inferior to that of Examples.

Comparative Examples 1 and 2, in which the average dispersion sizes of the first fatty acid metal salts are different from each other, are examples in which the requirement (C) is not satisfied. Comparative Example 3, in which no fatty acid metal salt was added as an internal additive to the toner particles, Comparative Example 6 in which no crystalline polyester resin was contained in the toner particles, and Comparative Example 7 in which no amorphous polyester resin was contained in the toner particles, are examples in which the requirement (A) is not satisfied. Comparative Example 4 using zinc stearate (“DFM1”) as an internal additive is an example not satisfying the requirement (B) because zinc stearate is a divalent metal salt. Comparative Example 5, in which no fatty acid metal salt was added as an external additive, is an example that does not satisfy the requirement (D).

It is found that Example 4 in which the toner surface exposure ratio of the first fatty acid metal salt calculated as the area proportion of the first fatty acid metal salt occupying the toner particle surface is 1% or more is better in the evaluation of the low-temperature fixability and the heat-resistant storage stability, particularly in the evaluation of the heat-resistant storage stability, than Example 2 in which the toner surface exposure ratio is less than 1%.

It is also found that Example 5 in which the toner surface exposure ratio of the first fatty acid metal salt is 5% or less is better in the evaluation of the low-temperature fixability and the heat-resistant storage stability, particularly in the evaluation of the low-temperature fixability, than Example 3 in which the toner surface exposure ratio is more than 5%.

It is found that Examples 4 and 6 in which the content of the first fatty acid metal salt in the toner particles is 0.5 mass % or more are better in evaluation of low-temperature fixability and heat-resistant storage stability, particularly in the evaluation of heat-resistant storage stability, than Example 7 in which the content is less than 0.5 mass %.

It is found that Example 5 in which the content of the first fatty acid metal salt in the toner particles is 2.0 mass % or less is better in evaluation of low-temperature fixability and heat-resistant storage stability, particularly in the evaluation of low-temperature fixability, than Example 8 in which the content exceeds 2.0 mass %.

It is found that, when the content of the crystalline polyester resin in the toner particle is defined as M_{C} mass %, and the content of the first fatty acid metal salt in the toner particle is defined as M_{TF} mass %, Example 8 in which M_{C}/M_{TF} is 2 or more is better in the evaluation of the low-temperature fixability than Example 9 in which M_{C}/M_{TF} is less than 2. It is also found that Example 5 having an M_{C}/M_{TF} of 2.5 or more is better than Examples 8 and 9 having an M_{C}/M_{TF} of less than 2.5 in the evaluation of low-temperature fixability and heat-resistant storage stability, and is particularly excellent in the evaluation of low-temperature fixability.

It is also found that Example 4 in which M_{C}/M_{TF} is 10 or less is particularly excellent in the evaluation of the heat-resistant storage stability as compared with Example 10 in which M_{C}/M_{TF} is more than 10.

It is found that Example 12 in which the average particle size of the second fatty acid metal salt is 0.5 μm or more has a lower minimum temperature (low-temperature-side fixable temperature) in the low-temperature fixability evaluation and is excellent in low temperature fixability as compared with Example 13 in which the average particle size is less than 0.5 μm.

It is also found that Example 11 in which the average particle size of the second fatty acid metal salt is 1.5 μm or less is particularly excellent in the evaluation of low-temperature fixability as compared with Example 14 in which the average particle size exceeds 1.5 μm.

It is found that Example 15 in which the content of the second fatty acid metal salt is 0.1 parts by mass or more with respect to 100 parts by mass of the toner particles is particularly excellent in the evaluation of low-temperature fixability as compared with Example 17 in which the content is less than 0.1 parts by mass.

It is also found that Example 16 in which the content of the second fatty acid metal salt is 0.5 parts by mass or less with respect to 100 parts by mass of the toner particles is particularly excellent in the evaluation of low-temperature fixability as compared with Example 18 in which the content exceeds 0.5 parts by mass.

It is found that Example 19 in which the adhesion strength of the second fatty acid metal salt to the toner particles is 20% or more has a lower minimum temperature (low-temperature-side fixable temperature) in the low-temperature fixability evaluation and is excellent in low-temperature fixability as compared with Example 20 in which the adhesion strength is less than 20%.

It is found that Example 1 in which the first fatty acid metal salt has a hydroxy group is better in the evaluation of low-temperature fixability and heat-resistant storage stability than Example 21 in which the first fatty acid metal salt does not have a hydroxy group.

Example 22 is an example in which magnesium stearate was used as the second fatty acid metal salt in place of zinc stearate used in Example 1 and the like. It is found that Example 22 is also excellent in low-temperature fixability and has sufficient heat-resistant storage stability.

The embodiments disclosed herein are illustrative in all respects and are not the basis for a limited interpretation. Accordingly, the technical scope of the present disclosure is not to be construed by the foregoing embodiments only, and is defined based on the description of the claims. In addition, meanings equivalent to the range of the claims and all changes made within the range are included.

### REFERENCE SIGNS LIST

1 Toner
10 Toner particle
11 Amorphous polyester resin (binder resin)
12 Crystalline polyester resin
13 Release agent
14 Colorant
15 First fatty acid metal salt (fatty acid metal salt as internal additive)
16 Second fatty acid metal salt (fatty acid metal salt as external additive)
2 Toner layer
3 Recording sheet

1. A toner comprising toner particles and an external additive adherent to a surface of the toner particles, wherein:
the toner particles contain an amorphous polyester resin, a crystalline polyester resin, a release agent, and a first fatty acid metal salt;
the first fatty acid metal salt is a trivalent or higher metal salt;
the first fatty acid metal salt in the toner particles has an average dispersion size of 50 nm or more and 500 nm or less; and
the external additive contains a second fatty acid metal salt.

2. The toner according to claim 1,
wherein a toner surface exposure ratio of the first fatty acid metal salt calculated as an area proportion of the first fatty acid metal salt to the surface of the toner particles is 1% or more and 5% or less.

3. The toner according to claim 1,
wherein a content of the first fatty acid metal salt in the toner particles is 0.5 mass % or more and 2.0 mass % or less.

4. The toner according to claim 1,
wherein a relationship of Formula (1) shown below is satisfied, where a content of the crystalline polyester resin in the toner particles is M_{C} mass %, and a content of the first fatty acid metal salt in the toner particles is M_{TF} mass %.
$$2 \leq {M}_{C} / {M}_{TF} \leq 10 \qquad ( 1 )$$

5. The toner according to claim 1,
wherein the second fatty acid metal salt has an average particle size of 0.5 μm or more and 1.5 μm or less.

6. The toner according to claim 1,
wherein a content of the second fatty acid metal salt is 0.1 parts by mass or more and 0.5 parts by mass or less with respect to 100 parts by mass of the toner particles.

7. The toner according to claim 1,
wherein the second fatty acid metal salt has an adhesion strength of 20% or more with respect to the toner particles.

8. The toner according to claim 1,
wherein the first fatty acid metal salt includes a hydroxy group.

9. A two-component developer comprising the toner according to claim 1 and a carrier.
